(19) United States
(12) Patent Application Publication
(10) Pub. No.: US 2017/0344981 A1
(43) Pub. Date: Nov. 30, 2017

(54) Increasing Efficiency of Transaction Network

(71) Applicant: SWYCH INC., Murphy, TX (US)

(72) Inventor: Deepak Jain, Richardson, TX (US)

(21) Appl. No.: 15/169,529

(22) Filed: May 31, 2016

Related U.S. Application Data
(60) Provisional application No. 62/169,197, filed on Jun. 1, 2015.

(51) Int. Cl. G06Q 20/38; G06Q 20/36; G06Q 20/34

(52) U.S. Cl. CPC G06Q 20/381; G06Q 20/342; G06Q 20/36

(57) ABSTRACT

The present disclosure is directed to increasing the efficiency of a transaction network. For example, a method includes receiving, through a communication network, digital information identifying a source network address for a sender, an funding source, a value, and a destination network address for recipient. A notification including digital information identifying the sender, an original prepaid item, the value, and alternative prepaid items is transmitted through the communication network. A response identifying one or more of the alternative prepaid items is received. A request to convert the value assigned to the original prepaid item to one or more values assigned to the one or more of the alternative one or more of the alternative prepaid items based on one or more predefined exchange rates is transmitted to a network element associated with the one or more of the alternative prepaid items.

### CLAIM OF PRIORITY

This application claims priority under 35 U.S.C. §119 to U.S. Provisional Application Ser. No. 62/169,197 filed on Jun. 1, 2015, the entire contents of which is hereby incorporated by reference.

### TECHNICAL FIELD

This invention relates to network communication, and more particularly to increasing efficiency of transaction network.

### BACKGROUND

Digital Wallets are growing exponentially, and numerous mobile applications and payment instruments options have been introduced over the last few years. The introduction of smart phones has fueled an unprecedented wave of innovation in the payment industry aiming to leverage the available technologies and connectivity to allow the user to have new options in managing their credentials and payment instruments. A large number of options are now available for consumers to download payment instruments onto their smartphones and use digital versions of their credentials in digital/mobile wallets. Consumers are finding value in the convenience and rewards offered by digital wallets, such as the Starbuck's and Dunkin Donuts mobile applications. In parallel, the use of Near Field Communications (NFC) as an in-store payment technology has gained popularity thanks to the launch of Google Wallet and Apple Pay.

In addition, the payment industry across the globe have slowly been moving to the adoption of more flexible and secure payment based on the EMV specifications. After a series of major security breaches, the US payment industry has finally elected to join this migration path from older magnetic stripe technology to the more secure chip based card technology to reduce a growing trend in payment card fraud. Government and payment networks mandate that issuing banks and merchants are now required to deploy EMV cards and EMV card readers or risk the losses due to fraudulent transactions. With an eye toward mobile payment, most of the new card readers (a.k.a payment terminals) which support EMV also have a native ability to accept Near Field Communications (NFC) transactions, and many merchants are opting to enable NFC acceptance of payment cards.

The rise in merchants' adoption of NFC capable payment terminals is creating incentives for banks to issue payment cards in a digital wallet format, capable of transacting at NFC or other chip enabled payment terminal.

Another issue facing the US payment industry is the recent large scale data breaches that have compromised tens of millions of consumers credit/debit accounts. To counter this issue, the US payment industry is starting to adopt tokenized payment credentials aiming to devalue the benefits that fraudsters could gain from stealing or compromising payment card numbers. NFC digital wallets, and digital wallets in general, provide a great advantage of being able to use the tokenization solution seamlessly without impacting the consumer experience. In particular, digital wallets supporting NFC are well suited to manage tokenized payment credentials thanks to their abilities to communicate regularly to cloud based token management services and delivery the payment credentials to the physical points of sale

In addition to NFC based implementations, the US consumer trend to leverage mobile payments is being addressed through other forms of payment credentials on mobile devices. Prominent players such as Chase Pay are bringing a mobile barcode-based payment scheme to market. This scheme has the capacity to leverage both tokenization and real-time debit authorizations to reduce the risk of data breaches.

### SUMMARY

The Open Cross Platform System (OCPS) is presented with aims to accomplish 4 objectives: a) Provide a cloud based secure platform that serves as an instant funds exchange system, allowing the user to submit a variety of payment options as a funding source such as a closed loop form of payment including gift cards, coupons, mail-in-rebates, vouchers, loyalty points or bitcoins that are otherwise difficult to redeem and subsequently allow the user to convert the redeemable value provided in the funding source into an instantly usable payment option that can be issued for the user's benefit and such option represented by an open loop VISA or MasterCard token, b) provide a system and platform capable of exchanging value from one form of funding to another form based either on local computation within the same platform exchange or through an exchange process conducted by interfacing with other third party value exchange platforms, c) Provide a system for users of digital wallets such as Apple Pay, Google Wallet etc. to be able to submit a variety of open loop payment options as a funding source from one of the payment instruments stored in their respective wallets with an intention to transfer money to another digital wallet users, especially across platforms and providers, and d) provide a system for recipients of payment forms to digitally and securely load the payment option sent to them as an open loop token in their preferred wallet that can be used across all merchants accepting open loop payment schemes, whether online or in physical stores and such token being independent of the actual form of payment that was actually sent by the sender (gift card, cash, bitcoin etc.)

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example system for communicating using a transaction network.

FIG. 2 is a flow chart illustrating an example method for increasing the efficiency of a transaction network.

FIG. 3 is an example block diagram for a transaction system.

FIG. 4 is an example block diagram for a user registration process.

FIG. 5 is a flow chart illustrating an example user registration process.

FIG. 6 is a flow chart illustrating an example for receiving money for a first time.

FIG. 7 is a flow chart illustrating an example voluntary sign up.

FIG. 8 is a flow chart illustrating an example method for binding an account to a mobile device.

FIG. 9 is a flow chart illustrating an example method for signing up using a client.

FIG. 10 is a flow chart illustrating an example method for online purchase protection.

FIG. 11 is a flow chart illustrating an example method for virtual card generation and user authentication.

FIG. 12 is a flow chart illustrating an example method for social media sending.

FIG. 13 is a flow chart illustrating an example method for leveraging credit scores for automatic funding.

FIG. 14 is a flow chart illustrating an example method for receiving money.

FIG. 15 is a flow chart illustrating an example method for sending money.

FIG. 16 is a flow chart illustrating an example method for sending gift cards.

FIG. 17 is a flow chart illustrating an example method for converting alternative form of payment.

FIG. 18 is a flow chart illustrating an example method for redeeming mail-in rebates or coupons.

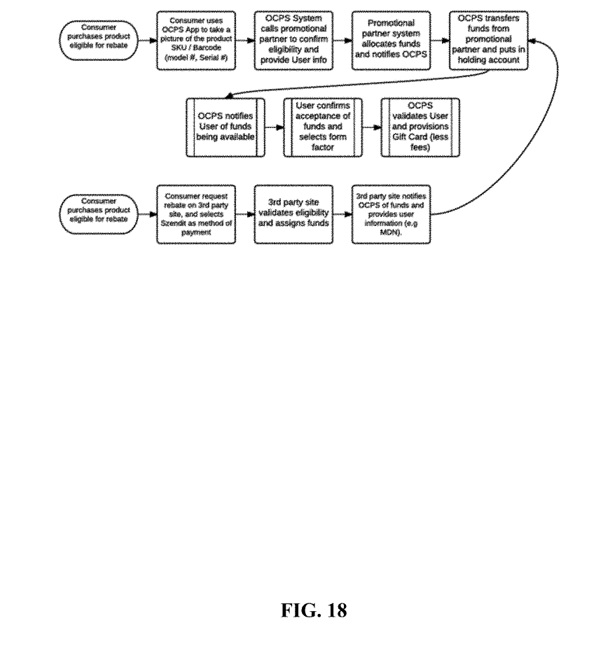

Like reference symbols in the various drawings indicate like elements.

### DETAILED DESCRIPTION

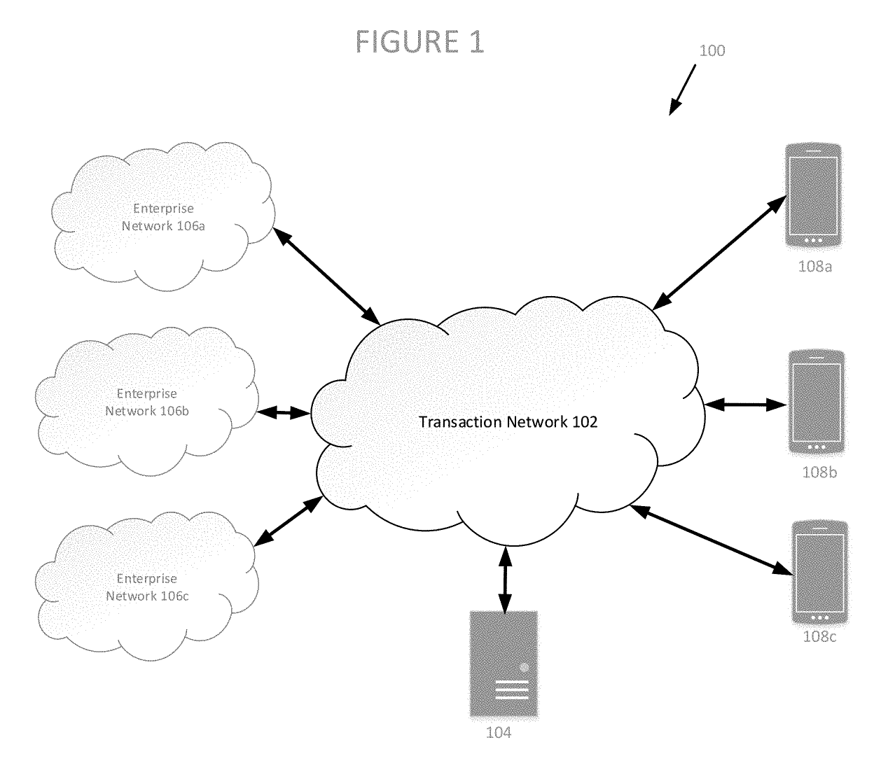

FIG. 1 is an example system for communicating using a transaction network 102. For example, the system 100 may include an Open Cross Platform System (OCPS) that serves as a secure cloud platform for value exchange services. In these instances, the OCPS may receive, on behalf of a user, funds or equivalent value for the purpose of exchanging and transferring it, for example, to another currency and/or digital value in a multitude of forms such as virtual gift cards, scanned checks or mail-in-rebates, cryptocurrencies such as bitcoin or loyalty rewards such as points or miles. OCPS may receive such funding requests through a variety of channels and interfaces, such as, for example, from the OCPS app or from 3rd party messaging apps such as iMessage, SMS; from social messaging apps such as Facebook, Twitter, WhatsApp, Skype; from retail systems such as Money transfer bureaus, ATMs, Kiosks, coin-changing machines, tellers or POS terminals, web applications or interfaces; voice based communication interfaces such as Amazon Echo, Siri, Google Now, Microsoft Cortana or other sources. OCPS may calculate the redeemable value of the funds to be transferred within a certain time period (e.g., real-time, a preset delayed execution). In some implementations, the digital value can be delivered to the recipient in an open loop or closed loop payment token issued for the benefit of the recipient and loaded in the recipient's preferred digital wallet, 3rd party money management app, bank account, or other account for collection by the user via, for example, a cash dispensing network.

As illustrated, the system 100 includes server 104, enterprise networks 106a-c, and client devices 108a-c communicably couple through the transaction network 102. The server 104 is designed to host all the necessary information that to identify and authenticate the user and store his digital system profile, preferences and related information, it also includes the rules of operations and other capabilities to operate the system including data management, security and auditing. The server 104 is configured to receive digital information identifying payment information and a funding source associated with one of the enterprise networks 106a-c and convert the funding source to a funding source identified by digital information received from a client 108. In some instances, the server 104 pre-authorize payment for the identified funding source associated with the enterprise network 106 and determine values for other funding sources based on a predetermined conversion rate. Once executed, the server 104 transmit digital information to an identified client 108 that identifies the original value and associated funding source as well as the determined value and associated funding sources. In response, the server 104 receives digital information from the client 108 identifying a selected funding source and transmits a request to the associated enterprise network 106 a request to purchase the identified funding source for the client 108 with the payment information.

The transaction network 102 facilitates wireless or wired communication between the enterprise networks 106a-c and any other local or remote computer, such as clients 108. The transaction network 102 may be all or a portion of a public network, a private network, a cellular network, and/or an IP network. While illustrated as single network, the transaction network 102 may be a continuous network logically divided into various sub-nets or virtual networks without departing from the scope of this disclosure, so long as at least a portion of the transaction network 102 may facilitate communications regarding funding sources between the enterprise networks 106a-c and the clients 108a-c. In some implementations, the transaction network 102 encompasses any internal or external network, networks, sub-network, or combination thereof operable to facilitate communications between various computing components in system 100. The transaction network 102 may communicate, for example, Internet Protocol (IP) packets, Frame Relay frames, Asynchronous Transfer Mode (ATM) cells, voice, video, data, and other suitable information between network addresses. The transaction network 102 may include one or more local area networks (LANs), radio access networks (RANs), metropolitan area networks (MANs), wide area networks (WANs), all or a portion of the global computer network known as the Internet, and/or any other communication system or systems at one or more locations.

The enterprise networks 106a-c are a network associated with an enterprise that provide one or more digitally-encoded funding sources. The enterprise may comprise a corporate or business entity, a government body, a non-profit institution, or any other organization. In some implementations, the enterprise manages the telecommunications and network services accessed using the enterprise network 106. The enterprise network 106 may communicate, for example, Internet Protocol (IP) packets, Frame Relay frames, Asynchronous Transfer Mode (ATM) cells, voice, video, data, and other suitable information between network addresses. In addition, while enterprise network 106 is illustrated as a single network, the enterprise network 106 may comprise a plurality of networks. Also, the enterprise network 106 may comprises different types of networks compatible with different protocols without departing from the scope of this disclosure. The client 108 are intended to encompass a personal computer, touch screen terminal, workstation, network computer, a desktop, kiosk, wireless data port, smart phone, PDA, one or more processors within these or other devices, or any other suitable processing or electronic device used for storing a digitally-encoded funding source. For example, the client 108 may be a PDA operable to wirelessly connect with an external or unsecured network. In another example, the client 108 may comprise a laptop that includes an input device, such as a keypad, touch screen, mouse, or other device that can accept information, and an output device that conveys information associated with a funding source.

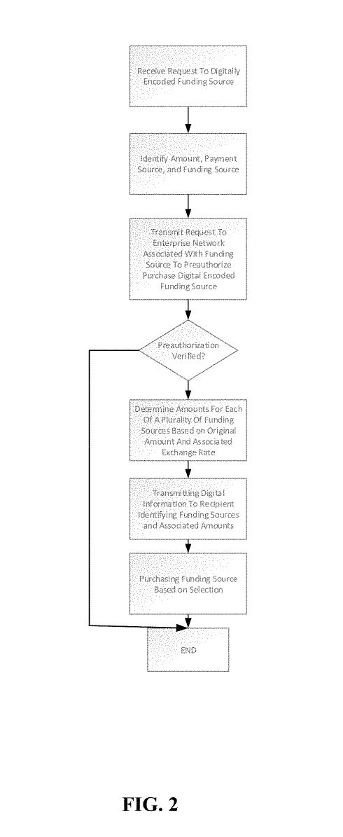

FIG. 2 is a flow chart illustrating an example method 200 for increasing the efficiency of a transaction network. Many of the steps in this flowchart may take place simultaneously and/or in different orders as shown. System 100 may use methods with additional steps, fewer steps, and/or different steps, so long as the methods remain appropriate.

Method 200 begins at step 202 where a request to digitally-encode funding source is received. In reference to FIG. 1, the server 104 may receive a request to purchase a digitally-encoded funding source from the client 108a for the client 108b. At step 204, an amount, a payment source, and a funding source are identified. In the example, the server 102 may determine the amount, the payment source, the funding source, and the network address of the client 108. Network address may include a phone number, an email address, a social media account, or other addresses associated with entities or individuals. Next, at step 206, a request is transmitted to an enterprise network associated with the identified funding source to pre-authorize a purchase of digitally-encoded funding source based on the amount. As for the example, the server 104 may determine that the enterprise network 106a is associated with the identified funding and transmit a request to pre-authorize a purchase of the funding source based on the identified amount. If the pre-authorization is verified at decisional step 208, then, at step 210, amounts for each of a plurality of different funding sources is determined based on the identified amount and conversion rates associated the different funding sources. Returning to the example, if enterprise network 106a transmits digital information to the server 104 verifying the preauthorization, the server determines converted amounts for other funding sources based on the identified rates and pre-determined conversion rates associated with the different funding sources. At step 212, digital information identifying the original amount and funding source as well as the converted amounts and different funding sources is transmitted the network address for the recipient. Again returning to the example, the server 104 transmits to the client 108b digital information identifying the original amount and funding source as well as the converted amounts and different funding sources using the network address for the client 108b. Based a selection received from the recipient, the selected funding source is purchased at step 214. In the example, the server 104 receives digital information identifying a selected funding source and, in response, transmits a request to the associated enterprise network 106 identifying the selection and network address of the client 108b.

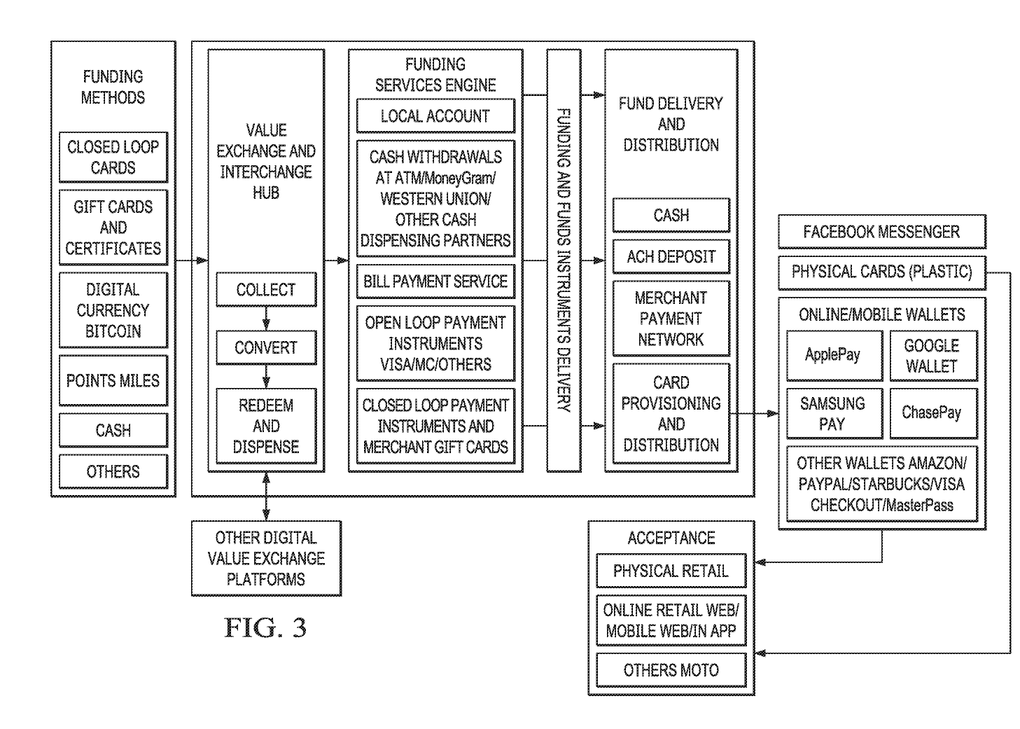

FIG. 3 illustrates one implementation 300 of the OCPS. However, OCPS may be implemented using other devise or modules without departing from the scope of the disclosure. FIG. 3, for example, shows a multi-input multi-output system (MIMO) implementation for the OCPS. The inputs to the system are several Funding Sources 302 that represent the forms of payments or currencies that the sender is interested in transferring to another user of the system. As illustrated, these funding methods 302 include Closed Loop Cards, Gift Cards and Certificates, Digital Currencies and Cryptocurrencies such as Bitcoin, Points and Miles, Cash and Others. Other funding methods 302 may be used without departing from the scope of the disclosure. Once the payment forms are received by the system, the system may exercise the first operation shown as Funding Exchange and Interface Hub 304. In this operation, FIG. 3, for example, shows 3 different types of exchange interfaces but other exchange interfaces may be used. The Collect interface 306 may be performed on a funding source that is holding the funds in a particular account belonging to the user, for example, a closed loop card or a gift card. The technical implementation of the Collect interface 306 would be for the OCPS Platform to connect to the issuer of the closed loop card and/or gift card and after proper authentication, request for funds to be withdrawn from such account. OCPS would provide a reconciliation mechanism that, for example, can be executed on a period basis to move such authorized funds from an account managed by the issuer of the funding source to an account managed by OCPS, on behalf of the user. The Convert interface 308 may be performed on a funding source that is holding the funds in a different currency, for example “bitcoin” than the intended target currency, for example US Dollars. The technical implementation of the Convert interface 308 would be for the OCPS platform to connect to an authorized exchange that is able to trade the source currency according to local, federal and international regulations. As part of the Convert interface 308, a market established or mutually negotiated “exchange rate” would be applied to determine the value of the source currency and the equivalent funds in the target currency after conversion. Upon acceptance of such a transaction, on behalf of the user, the OCPS platform would submit the source funds for conversion and receive the target funds from the exchange. Similar to the Collect interface 302, the reconciliation mechanism will be performed periodically to move and settle the funds between the different holding institutions involved. The Redeem interface 310 may be performed on a funding source that is holding certain rewards for the user, for example miles, points, discount offers or rebates that can be exchanged for certain cash value, for example in US Dollars. The technical implementation of the Redeem interface 310 would be very similar to the Convert interface 302 except that instead of negotiating the conversion rate from an exchange, the “redemption” rate would be negotiated directly with the brand or service provider that is holding the loyalty points in a program of which the user is a member of. Alternatively, the negotiation and redemption of the loyalty points can also be performed with an aggregator or trader or a representative hired by various loyalty program providers to administer the programs. These interfaces may be performed in sequence. For example, a user may select a gift card in Euros that needs to have the funds first “collected” from the source account and then “converted” from Euros into, for example, US Dollars. Once the funds are “collected”, converted or redeemed, they are ready to be dispensed to the target user.

The next illustrated operation is referred to as the Funding Services Engine 312.

FIG. 3, for example, shows various mechanisms through which the funds can be dispensed. For example, the various methods shown in FIG. 3 inside the Funding Services Engine 312 are Local Account 314 where a new local account holding the target funds is created for the user, Bill Payment Service 316 where the funds are used to pay an e-bill for the user, Cash Withdrawal 318 where the funds are made available to the user for withdrawal in cash using a cash dispense mechanism such as ATM or cash counters run by money transfer companies, Open Loop Payment 320 where an instant prepaid account is created with a bank pertaining to a particular payment scheme like Visa and Mastercard is created for the user and funds credited into that account and Closed Loop Payment 322 where an instant prepaid account, for example, a gift card is created for the user and funds deposited into that account. The funds may be dispersed using other methods without departing from the scope of the disclosure.

Once the funds are dispensed into an account belonging to the target user, FIG. 3 shows the next interface to be exercised, which is the Funds Distribution 324. In this interface, FIG. 1, for example, shows different methods for distribution, such as Cash 326, ACH or Wire transfer 328, Merchant Payment Network 330 or Card Provisioning 332. In the Cash method, a notification is sent to the user with instructions for collecting the cash from a participating ATM network, cash counter, or other participant or device. In some implementations, instructions may request that a confirmation code be provided. In the ACH or wire transfer method, funds are transferred to the local account owned by the user using, for example, an account number and a routing number provided by the user. In the Merchant Payment Network 320, a gift card is sent to the user with, for example, a barcode showing the account number for the gift card. In the Card provisioning method, a virtual card may be issued pertaining to the open loop or closed loop account where funds are held and the account info then wirelessly provisioned inside a digital wallet, for example Apple Pay or Google Wallet. A physical card can also be issued to the user if requested that can represented either the closed loop card containing the funds, or a gift card or an open loop prepaid card containing the funds. Once the funds are distributed, they may be accessible outside the OCPS system by the target user. FIG. 3, for example, shows that the user can receive the notification of funds available using social media services, such as the Facebook Messenger. FIG. 3 also shows that the user can receive a plastic card representing the account holding the funds. FIG. 3, for example, shows Mobile and Digital Wallets 334 where cards representing the funds are provisioned. These Mobile and Digital Wallets 334, for example could be wallets that can house multiple cards from different institutions such as “Apple Pay”, “Google Wallet”, “Samsung Pay”, “Amazon” or “PayPal”. Alternatively or in combination, these could be mobile applications that can use funds using a store or brand account such as “Starbucks app”. Once the user receives the funds in either the form of a plastic card or as a card provisioned inside his mobile or digital wallet, FIG. 3 describes that the funds can, in some implementations, be used across different merchants. FIG. 3 shows these merchant types to be, for example, a retail store where goods are purchased for immediate carryout, or an online e-commerce store where digital or physical goods are purchased for delivery after purchase, for example by mail or courier service or via electronic delivery, for example a digital movie download or also an “in-app” payment within a mobile application where virtual goods can be purchased instantly, for example, a video game.

The system may support a rich set of inputs and outputs for various functionalities provided as well as the phase during which the interface is exercised. The interfaces to the system may be a group of user accessed interfaces supported by a set of easy to manage UIs to simplify the user experience. The above interfaces may be defined by the proposed system or by the entities to which the system interfaces to or connects. The interfaces and API may be flexible and compatible with the prevailing technologies including, for example SOAP, REST, or others. The system may include one or more of the following: account creation, authentication, account management, funds collection, funds exchange, funds exchange policies, refunds, bill payment, cash dispensation, funds transfer, alerts and notification, data provisioning, security and risk management system, compliance and OFAC checking, credit and identity checking, dispute management, customer service, issuance, life cycle management, reporting, analytics, user interfaces, connectors to other platforms, adaptors to translate 3rd party API's to standard system API's, internal and external card provisioning module, account tokenization and detokenization modules and a card/account management module, mobile application, SDK, and/or others.

OCPS may be capable of exchanging the collected funds from one form to another based on value exchange process and pricing based on industry exchange rates received from 3rd party providers or proprietary conversion rates maintained by the OCPS platform. OCPS may provide an offer to the recipient with redeemable value of the funds being transferred based on applicable exchange rates and may be capable of converting and delivering the funds if the offer is accepted or delivery the funds in the original sent form if the offer is not accepted. In some cases, the applicable exchange rate may be adjusted based upon a specific promotion, discount or sponsored incentive from a 3^{rd} party. OCPS may notify the users, at the source or destination, of activities or events related to their accounts and the OCPS transactions with or without conversion and redemption details.

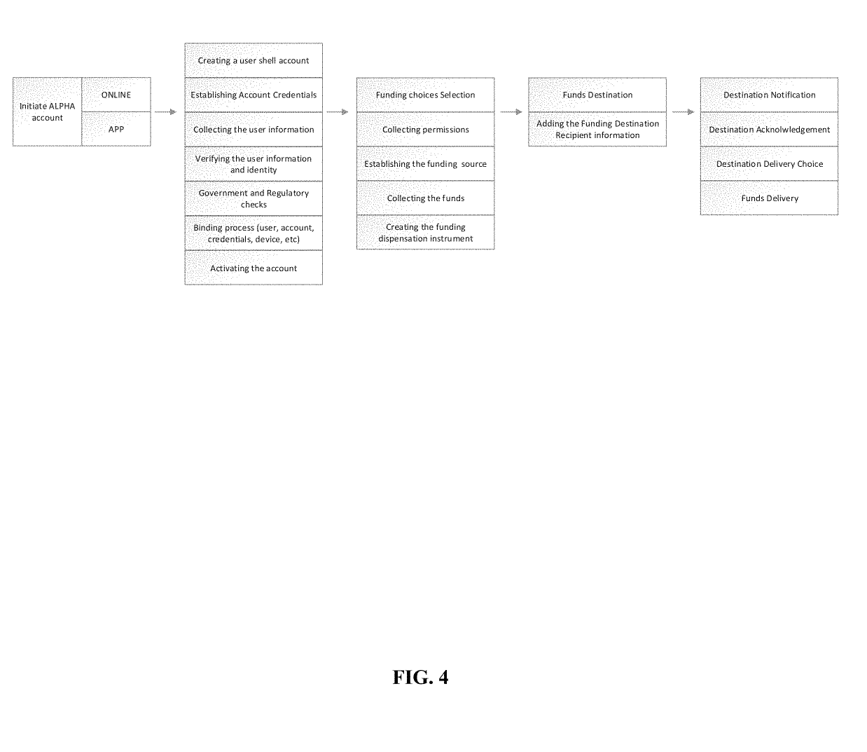

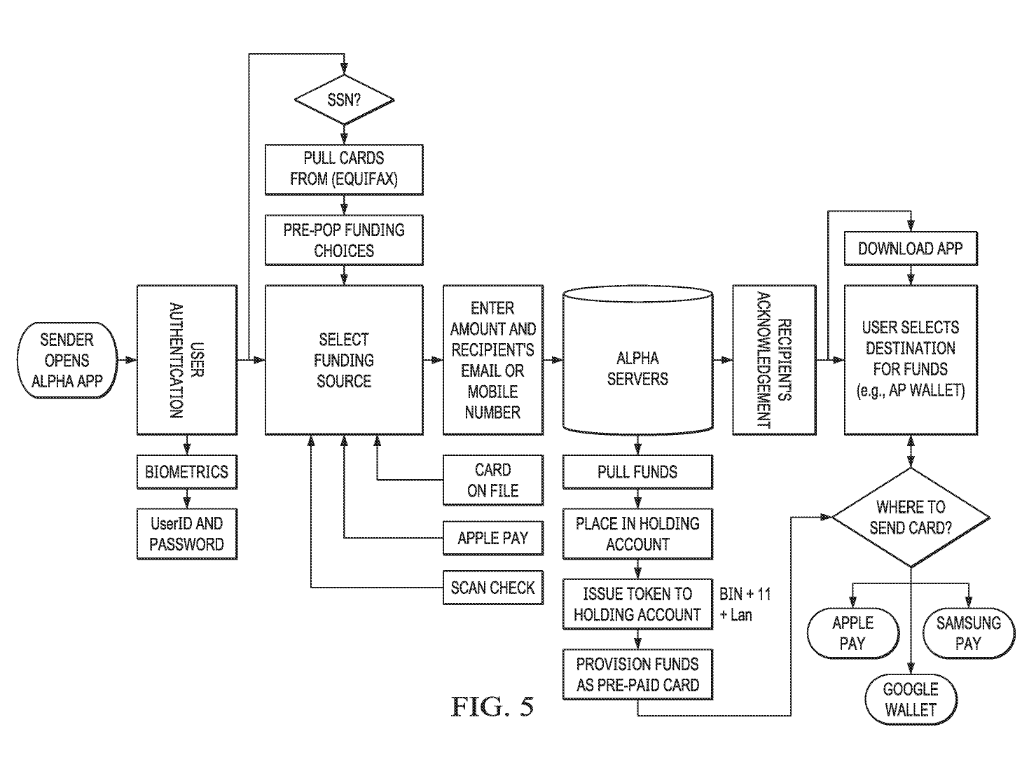

FIGS. 4 and 5 describes an example user-registration process that is initiated when the user attempts to initiate a money-send process for the first time. For example, shows that the user can initiate the process using, for example, an online internet session from a browser, from a smartphone application, or other method. FIGS. 4 and 5 then describes the user's identification and authentication process followed by the system. For example, the system may identify the user automatically using, for example, the device identifier of the device used to access the system (e.g., user's email address, his mobile phone number). In some instances, the system can invite the user to setup a biometric method for identification and authentication, for example, his fingerprint captured by a sensor on the device he is using to access the system. Once the user is properly identified, the system may initiate the account creation process. For example, the system can create a shell account for the user with the information collected.

Next, the system may collect more information from the user to activate his account and setup funding sources for him to use to initiate the fund transfer. For example, some of the additional information requested by the system may include user's personal information to verify the identity of the user per government and regulatory requirements. The system may then provide various options to the user for setting up his funding sources. For example, the system may automatically link to a credit bureau agency like Equifax (using the user's social security number or other acceptable forms of identity verification) and present to him the various active accounts that are captured in the user's credit history as a selection for funding choices. As an alternative or in combination, the system may allow the user to manually enter the account information, for example the account number, expiry date and CVV code in the case of the funding source being a credit card or an account number and a routing number in the case of the funding source being a bank account. The system may allow other forms of funding sources, for example selecting a card already provisioned in a digital wallet on the user's phone like Apple Pay. System may allow the scanning of a check, or of a barcode representing a gift card or a mail in rebate as a funding source. The system can also link to the user's other accounts such as points or mileage rewards account held at a different institution or bitcoins held in a wallet on his mobile phone as a funding source as well. Once the funding source is established, the system may validate the funding source and receive the funds to be transferred. The technical implementation of the validation of the funding source can vary based on capabilities supported by the institution holding or administering the funds on behalf of the user. For example, one of the methods used for validation of the funding source is for the user to provide his login credentials to an account management service offered by the holding institution. In this case, the OCPS platform can log-into the funding account, with the user's permission, and verify the authenticity as well as establish the account ownership of the user. Another example for the validation of the funding source would be for the OCPS to pre-authorize a transaction against the funding source, as a merchant, for the full amount of the transaction that is being intended or for a large enough amount. Upon receipt of a positive authorization from a merchant acquirer that the transaction would be processed successfully, OCPS can mark the funding source and funds as valid. Once the funds are validated, the system may request that the user establish the funding destination. For example, the system may ask the user to manually enter the recipient's email address or phone number. Alternatively or in combination, the system may link to the address book on the sender phone and present a selection of users which can be the destination for the funds. Alternatively or in combination the system may link to an address book stored in the cloud or the user's social networking account like LinkedIn, Whatsapp, Skype or Facebook to present a selection of connected users that can be the destination for the funds. Once the funds are validated, the destination is setup and the user permission is sought to continue with the transaction, the fund delivery process. FIGS. 4 and 5 shows also the notification of delivery to both the sender and the recipient and confirmation of funds being transferred to both the sender and the recipient as well.

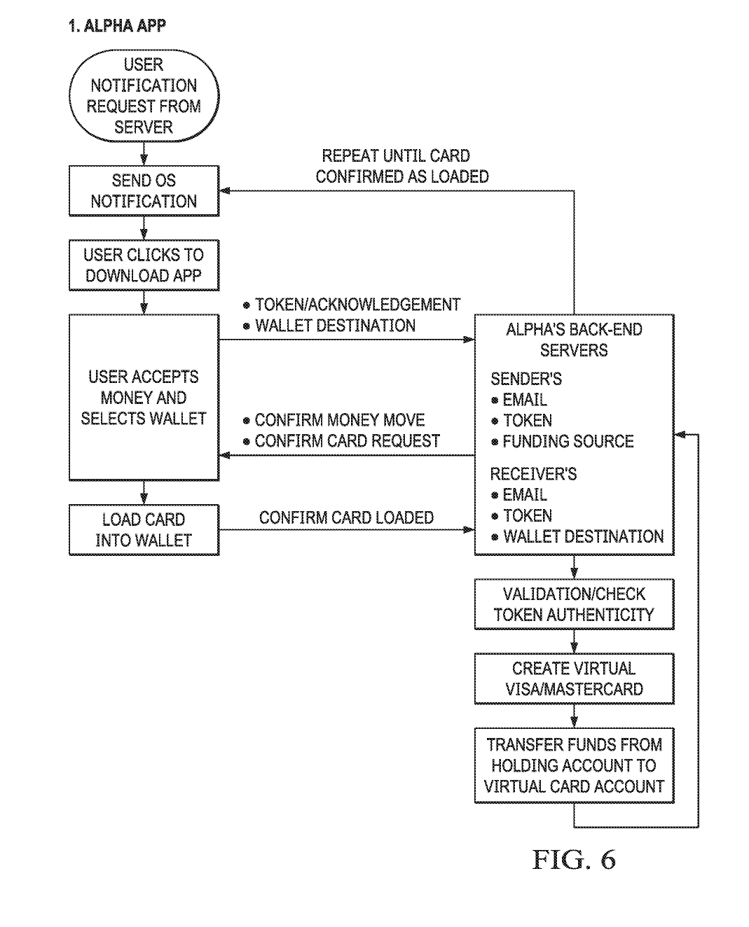

In some implementations, OCPS may support strong authentication of both sending and receiving users and provide initiator and recipient control on their funds sending and receiving activities. FIG. 6 illustrates an example process when a new user is invited to sign-up for the system based on his contact information selected as destination source by a sender. As illustrated, a user may receive a notification (e.g., on his mobile phone) that money has been sent to him by another user. When the user has clicked on the notification or other mechanism for initiating the process, the system can, in some implementations, automatically create a shell account for the user. Once the notification is received, the user may be invited to download a mobile app for the system. FIG. 6 shows that when the user has download the app and launched it for the first time, the system may complete the registration process by following a process similar to the steps defined in FIGS. 4 and 5 (identification and selection of authentication choices for the user). Once the user account is registered and activated after receiving the requested user information, the system may request that the user to consent to receiving the money sent to him. When the user accepts the money transfer request, the system may request that the user to select the form in which he wishes to receive the money. In some implementations, the system may present a plurality of forms that user may select. For example, the user may decide to receive the money in the form of a virtual card to be installed in his preferred digital wallet on his mobile phone. In this case, the system may follow the process defined in FIG. 1 of funds exchange. The mobile app may then send the user selection of the destination digital wallet to the system, for example Apple Pay, which may then requests the system to initiate the fund distribution process as described in FIG. 3. In this case, the system may prepare a virtual card token to be provisioned inside the user's Apple Pay account. For example, the system may connect to the issuing bank and/or the payment network to prepare and validate, for example, a token. Once the token for the virtual card is issued, it may be sent to the token provisioning system, for example, Apple Pay, to download the token to the user's digital wallet. Once the wallet download is successful, FIG. 5 illustrates that the system may capture the information in its database and provides the notification to the sender for successful delivery of the funds. If the process is interrupted or fails, the system may retry the notification as well as other steps until the user successfully accepts the funds and completes the fund reception process or if the user elects to decline the funds transfer process.

Consumers may also sign up to the OCPS service through their PC or app without an immediate need for sending or receiving money in order to create an account for future use. The consumer sign-up process may be driven by an interest in using the service or as a part of a promotional activity or other services driving the consumer to create an account or by an invitation through friends or other means. FIG. 6 summarizes example processes by which a registration may be performed by the user and the subsequent setup of a funding source to be used for sending money at a later date. FIG. 6 illustrates, for example, that the user may initiate the registration process using, for example, a tablet or smartphone app. In this case, the user may be identified and authenticated first and the process used for identification and authentication may be the same as described previously in FIG. 4 (first time send) and FIG. 5 (first time receive). Once the user is registered and authenticated and is inside the mobile app, two scenarios are illustrated. FIG. 6 shows that, for example, a user may either have a digital wallet already present on his smartphone with funding sources provisioned or a user may not be a digital wallet user. FIG. 6 shows that if the user is a digital wallet user, for example Apple Pay, then the app may detect that and present funding sources already present in his Apple Pay digital wallet to be used as the funding source for the money transfer. If the user is not a digital wallet user, the app may allows the user to use alternative method to enter his funding source information. Methods used could be, for example, manual typing of the card number and other details linked with the funding source being setup. FIG. 6 illustrates that, for example, the app may allow the user to take a picture of his payment card or blank check linked to his funding source to automatically provision this funding source in the system. FIG. 6 illustrates a similar process used by the system if the user makes the registration online using the website offered by the system. FIG. 6 illustrates that the system may allow the user to purchase a new funding source from within the app or the website. For example, the user may link to another service like ebay.com to purchase a gift card from a selection of merchants and assign this purchased gift card as the funding source. FIG. 6 illustrates that the user may also link to other funding sources like Bitcoin wallet, airline mileage accounts or loyalty program points and use those in the selection of funding sources. FIG. 6 illustrates that whether the funding sources are selected from another digital wallet or manually entered or scanned, or linked from an alternative provider or purchased from within the app, and whether the user is performing the action in the app or online, the selected funding sources may be synced or otherwise associated with the OCPS system and securely affiliated with the user's account for future transactions.

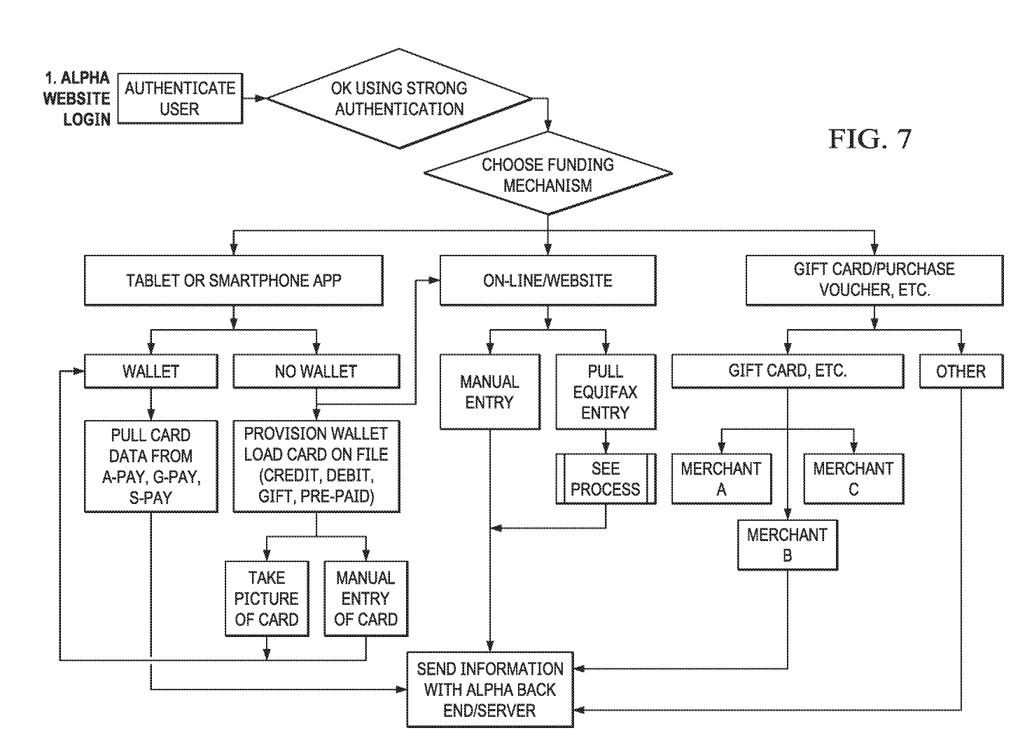

FIG. 7 may extend the registration process and describes the actions performed within the OCPS system related to the user and his mobile device. As described in FIG. 6, the user may register for the service using a variety of methods. As part of the registration process, a shell account may be created for the user when he registers. FIG. 7, shows that for additional security, for example, after account creation, a confirmation email may be sent to the user's chosen contact email address with a token to confirm his identity. Once the confirmation is received, the user account may be verified. FIG. 7 shows that in certain cases, for example, the system may request additional KYC (Know your customer) information from the user for further identity verification. Once received, the user account setup may be complete. However, before the user uses the system, his account may be bound to his mobile device on which the app has been downloaded. In order to do that, FIG. 7 shows that the OCPS system may collect, in some implementations, device information from the user. For example, this information may be the user's Mobile Device Phone Number (MDN), a unique mobile device ID such as Apple ID or Android ID, his SIM card number, his International Mobile Equipment Identity number assigned to his device hardware (IMEI), his computer's MAC address (in case of online use), or other information. In some other cases, for example, additional information may be collected such as, for example, GPS location, device hardware and firmware version, network operator information, unique parameters associated with the device such as signatures and other characteristics, or other information. The OCPS system may use these characteristics to generate a string (e.g., a unique 11 digit number) that can be then combined with another string (e.g., a 4 digit BIN number affiliated with a financial institution) and a check digit to create, for example, a unique 16 digit account number for the user, hereafter referred to as the OCPAN (Open Cross Platform Account Number). The algorithm may be used by the system to generate the OCPAN. For example, each time the user accesses the system with the same device, the system may validate the OCPAN number and use the information in additional security and fraud control measures.

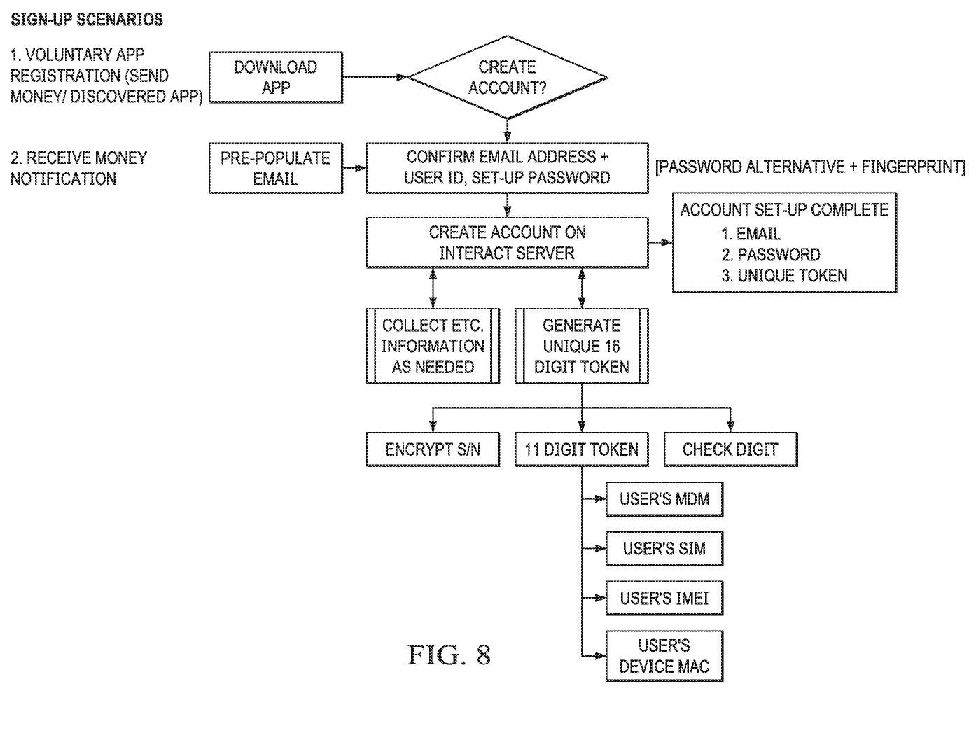

FIG. 8 illustrates an example where the user initiates the sign-up from a PC but completes it on the mobile device. The sign-up process may include one or more of the following: collection of user provided information, creation of a shell account, validation of the user provided information, binding the user information to the shell account, activation of the account, processes are similar to as described in the previous paragraph for FIG. 5, or others.

As a part of the user information collection process, the user may elect a user ID and password, PIN, or other identifier to establish credentials to be used to, for example, log in to their account. The user may elect to leverage existing credential such as Facebook Connect or Google O-AUTH or an industry standard such as OpenID or other third party credentials supported by the system. The user may provide information to allow the platform to communicate to them such email address, phone number, or other. This information may be verified and may be used to send notification including, for example, authentication related messaging, changes in the terms of service, confirmation of service rendering, or others. The phone number may be used by the system to send a secure URL that may be used on, for example, the mobile phone to download the Service mobile application. This process may not be used only to verify the validity of the phone number but may be used, in some stances, for binding the user account to the devices though which the user may access the service in a trusted manner. The process of linking the account and devices may include, for example, the use of NFC, Bluetooth or QR or other supported technologies that may be used to allow, for example, a token exchange between components.

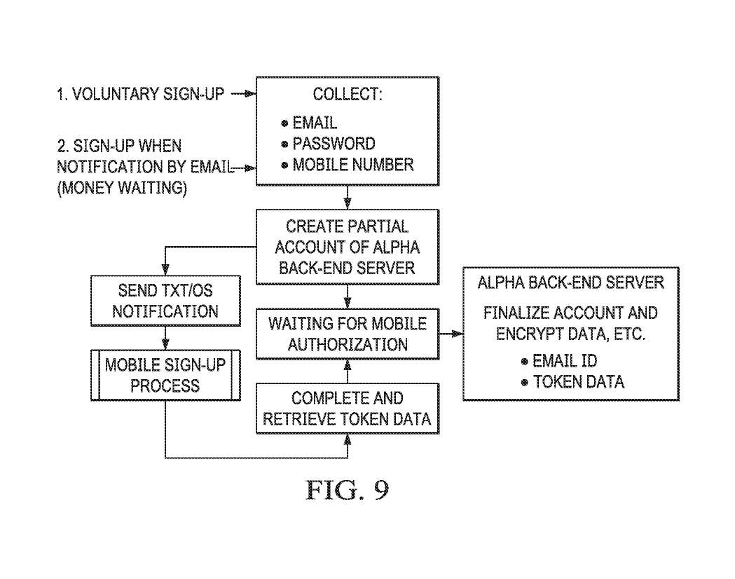

The system may use the OCPAN number and the funding sources setup by the user in his account for shopping at popular online retailers. Following the various breaches at the merchants, the consumer may desire the reduction of their exposures to future breaches while maintaining a specified level of flexibility in their funding sources. The system may offers an approach wherein the user of the OCPAN number to perform a purchase at a merchant may prevent the user's funding source card data to not be used online from where it can be compromised and also offer the flexibility for the user to switch his funding sources and select the right funding source to use for finalizing transactions. In other words, the user may self-authorizing the OCPAN usage at an online merchant by validating his funding source within the app during the transaction process. FIG. 9 illustrates an example method. When the user checkouts his purchases at a merchant, he may be presented with the amount to be paid in, for example, the shopping cart, inclusive of taxes and shipping if applicable. The user may open the OCPS app and enter the amount in the purchase (e.g., online) portion of the app. The app may request him to select the funding source that the user wants to use for this transaction and amount. The system may remember the user selection of the amount and the funding source. The system may generate verification code (e.g., a unique 3 or 4 digit code typically printed on the plastic card which is commonly used in online purchases together with the account number and expiry date). This verification code may be generated by the system using an algorithm (e.g., proprietary) using, for example, the user's information present in the system, funding source selection, secret keys, the transaction amount information, or other information. The algorithm may be used is such that a change in the amount may change, for example, the value of the verification code. In addition to the verification code that may be entered in, for example, the CVV2 or CVC2 field on the merchant page, the system may introduce other authentication data such as, for example, a numeric value, alphanumeric value, or other string as, for example, a part of the name on card field. The app may display information for the user to perform a online transaction, for example, the OCPAN number, the expiry date, name on card, the verification code, his registered zip code, and/or other information. In some instances, the consumer may manually insert information into the merchant checkout page form. The processing of the transaction may follow the standard transaction processing steps may allow that the transaction arrives at the OCPS issuing bank for authorization (e.g., since the BIN number is contained in the OCPAN). The issuer may forward the transaction to the OCPS system. The OCPS system may validate, for example, a verification code received from the system with the amount received from the merchant and if it matches, may provide an issuing bank with a source data to authorize and settle the transaction. Once the bank receives the actual funding source data, the system may execute normal typical process of transaction authorization and provide approval of a transaction to a merchant. The user may use his OCPS app and a funding source in the app to perform an online transaction without a) entering the real funding source information on the website and b) without the merchant website or the processing architecture to be modified.

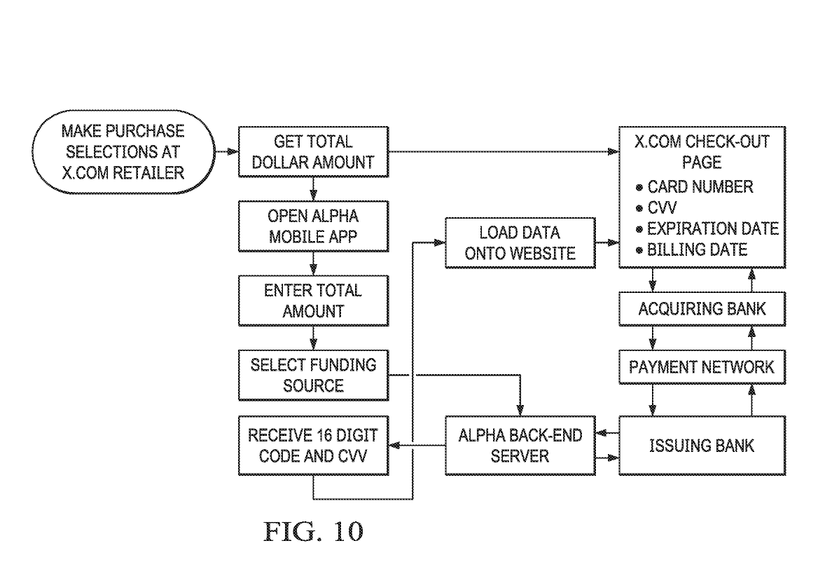

FIG. 10 illustrates an example process of virtual-card-number generation when the recipient of the funds decide to accept his funds in the form of a virtual card to be loaded into his digital wallet of choice. A consumer with an OCPS account may send funds to other users within or outside the OCPS platform. Once a user has been authenticated to OCPS, they may initiate a Fund Sending Process as described in FIG. 4. If the recipient has an existing OCPS account, the sender may use their user ID, phone number, mobile number, or other information to identify the recipient to the platform. The platform may query its data records to identify the recipient. The platform may conduct a validation process to ensure that the recipient is the intended recipient including the sender confirming that the transaction should proceed. The validation process used by the OCPS platform to ensure that the recipient is a valid recipient uses the account information created by the user during account registration and comparing it with the credentials used by the user while receiving the transaction. For this purpose, the OCPS platform can use the details transmitted by the user during account registration, for example but not limited to, device in use, SIM card number in use, mobile network code, equipment identifier and compare them with the same details available from the user in real-time while the transaction is being attempted. If the recipient has an OCPS account, the funds may be setup for distribution from the sender to the receiver in the original currency provided or in an exchanged forms based on input from the sender and/or receiver. If the recipient does not have an OCPS account, they may be notified of their available funds and requested to establish an account to access the funds. Once the user accepts the notification, the system may invite the user to register with the OCPS system using, for example, the process described in FIG. 5. Once the recipient has indicated their preference to receive their funds in the preferred digital wallet of their choice, the system may create a Virtual account number that can then be used by the user to access his funds. The algorithm used in the generation of the VAN number, as shown in FIG. 10, may take into account the OCPAN numbers related to both the sender and the receiver of the funds as well as other information such as the recipient registered mobile number and a transaction identifier or sequence. The VAN number created is generally affiliated with the BIN number of the OCPS partnering financial institution that is hosting the user accounts and the funds. Once the VAN is created, funds may be allocated (or moved from the ledger account) to the VAN account so that they are accessible by the user using the credentials of the VAN.

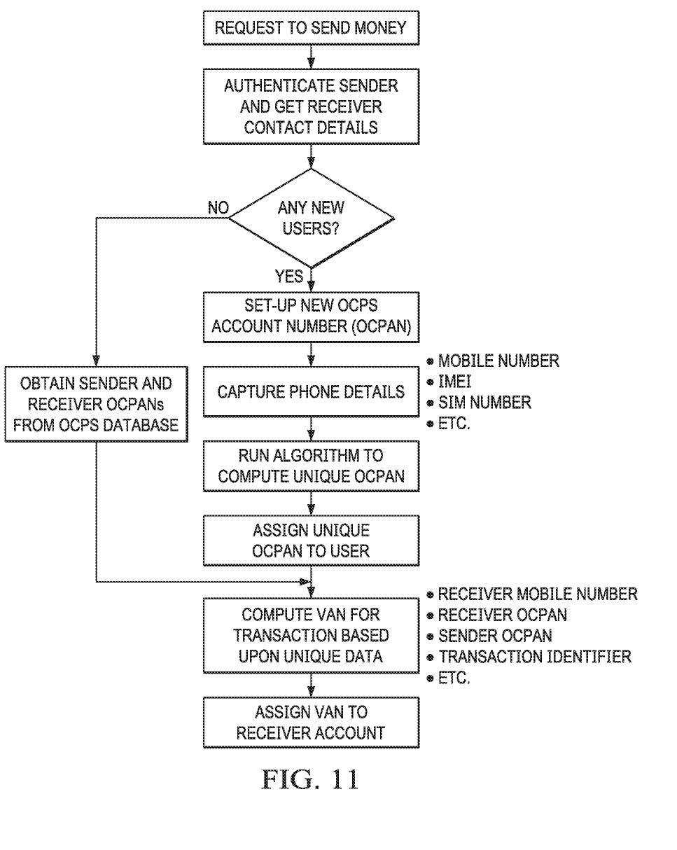

FIG. 11 shows that, for example, in addition to the other methods described, a user may initiate a fund transfer request without using the OCPS app or the OCPS website but using a 3rd party messaging apps such as Twitter or text message (e.g., SMS). The sender may initiate the request by sending, for example, a text message to the OCPS platform. In some implementations, a specially allocated destination number may be used and may be easy to remember using, for example, hashtags or shortcodes. The message may include the amount of the funds to be transferred as well as an identifier of the recipient, for example his mobile number or email address. OCPS responds to the message received by requesting the sender to open the mobile app, or install the mobile app or provide a link to the OCPS online page. The user uses the OCPS app or web page to complete the fund transfer process as described in FIG. 4 or FIG. 7.

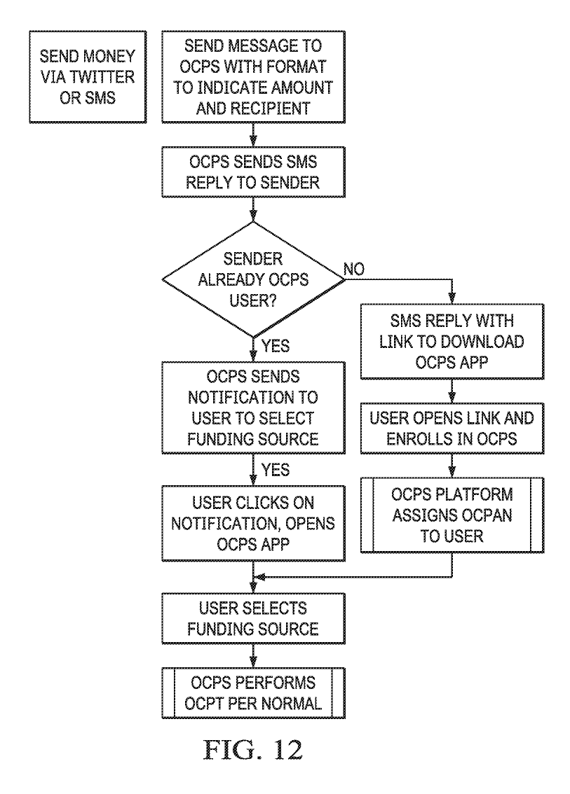

FIG. 12 illustrates an example mechanism for the user to setup funding sources inside the OCPS system. For example, when the user logs into the OCPS system using the app or the website, he may be presented with an option to automatically find funding sources owned by him. When the user selects this option, the system may request identifying information (e.g., Social Security Number). The system may then use the identifying information to make, for example, API calls to credit bureaus such as Equifax or TransUnion or online portfolio management services such as mint.com to discover the funding sources that have been issued to the user by financial institutions. These funding sources may then be presented to the user in a selection. The user may select one of these funding sources to proceed with a money transfer transaction or provisioning of the funding source into the system for a future transaction. In some cases, the financial institution may request that the user to login to the financial institution to verify his identity before this funding source is available for a money send transaction or the financial institution may request the user to enter, for example, a second factor token to confirm, such as a token sent to the user by the bank or financial institution directly.

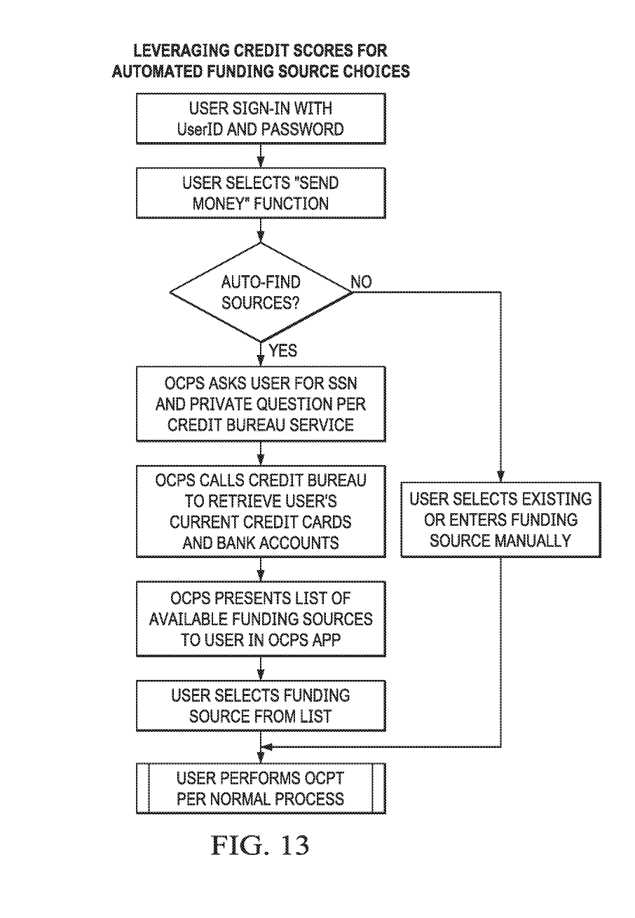

FIG. 13 illustrates an example consumer experience and options available to a consumer when they are the intended recipient of a money transfer. The process begins when a sender wishes to transfer money to a receiver. After validating the sender and confirming funds availability, the OCPS may determine the best way to notify the receiver of the pending transfer. The best method will depend upon whether the receiver already has the OCPS app installed on their mobile device. If the OCPS app is installed, then OCPS servers may have already authenticated the receiver, and their mobile device or other device, and thus provide some level of security of the funds transfer. In this case, the receiver can, in some implementations, send an OS-level notification, which may open the OCPS app upon, for example, action by the receiver. Once the OCPS app is open, the receiver may provide details of their pending transfer, and may be prompted to select one of the available payment form factors in which to receive the funds. If the receiver chooses to deposit the funds into their bank account, then OCPS may perform an ACH transfer to the user's pre-established bank account. If the receiver chooses to receive the funds via an Open Loop pre-paid card (e.g. Visa/MasterCard), then the receiver may select which digital wallet in which to store the card, and then OCPS may action the OCPS partner bank to provision a pre-paid card into the receiver's digital wallet of choice, such as described in FIG. 10. If the receiver chooses to receive the funds as a merchant gift card, the user may choose which specific merchant card they desire, and in which digital wallet it will be stored. Then, OCPS may ask the OCPS merchant gift card partner to provision a card into the chosen wallet. The OCPS may also purchase a virtual gift card from a gift card distributor and receive digital credentials for the gift card which it can then provision inside the digital wallet of the user. In these cases, the OCPS platform may able to validate the security of the connection to sender and receiver because the OCPS app is installed on both users' phones and leverages the OCPS security mechanism. FIG. 13 (2) illustrates an example scenario when the receiver does not yet have the OCPS app installed. Here, the OCPS platform may send, for example, an SMS message to the targeted receiver, which may include a message about their pending transfer and a link to the corresponding App download location. Once the receiver completes the OCPS app enrollment process, they may continue through the prompts outlined in FIG. 13 (1) above to choose how they wish to receive their funds.

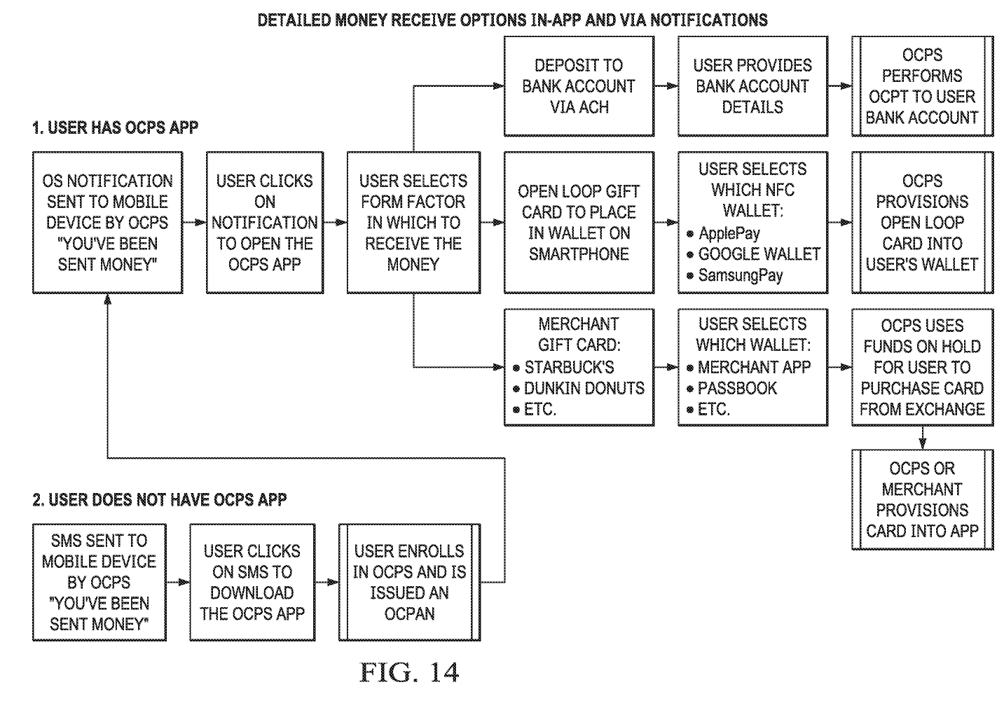

The OCPS system may allow senders to initiate fund transfers in a variety of ways. FIG. 14 illustrates example methods to initiate the transfer, along with example steps taken by the sender and the OCPS system to complete the transfer. In the first scenario, if the sender uses their OCPS app on their phone or other mobile device, then the OCPS app may authenticate the user via PIN, Biometrics, and other security techniques that binds the user to that mobile device or mobile device. If the sender uses the OCPS online portal, then the OCPS may use two factor and/or out-of-channel authentication methods commonly used in on-line portals. In both In-App and Online versions, the sender may next select the recipient of the money transfer. OCPS may allow the sender to quickly pick from their on-device contacts list, or other contact list (such as Facebook friends) and associates that person's profile with a mobile number or mobile device. OCPS may then confirm the phone number is valid before proceeding. Once confirmed, the sender may be prompted to select a funding source and amount, as described elsewhere in this disclosure. A second scenario is also illustrated in FIG. 12 in which the sender can initiate a money transfer directly from an SMS short code, or via a Twitter Tweet. In these instances, the OCPS may perform the additional step of notifying the sender for more information as outlined elsewhere in this disclosure. In both scenarios, the OCPS may proceed to transfer the selected amount from the sender's funding source into a holding account while validating the recipient (also described elsewhere in this disclosure). Next, OCPS may generate a VAN for this money transfer, which may be a function of several factors, including but not limited to the transaction amount, and both, the sender's and receiver's profile within OCPS. Lastly, the recipient may confirm the form factor for which they desire to receive the funds (also described elsewhere in this disclosure), thus allowing the OCPS to complete the transfer of funds.

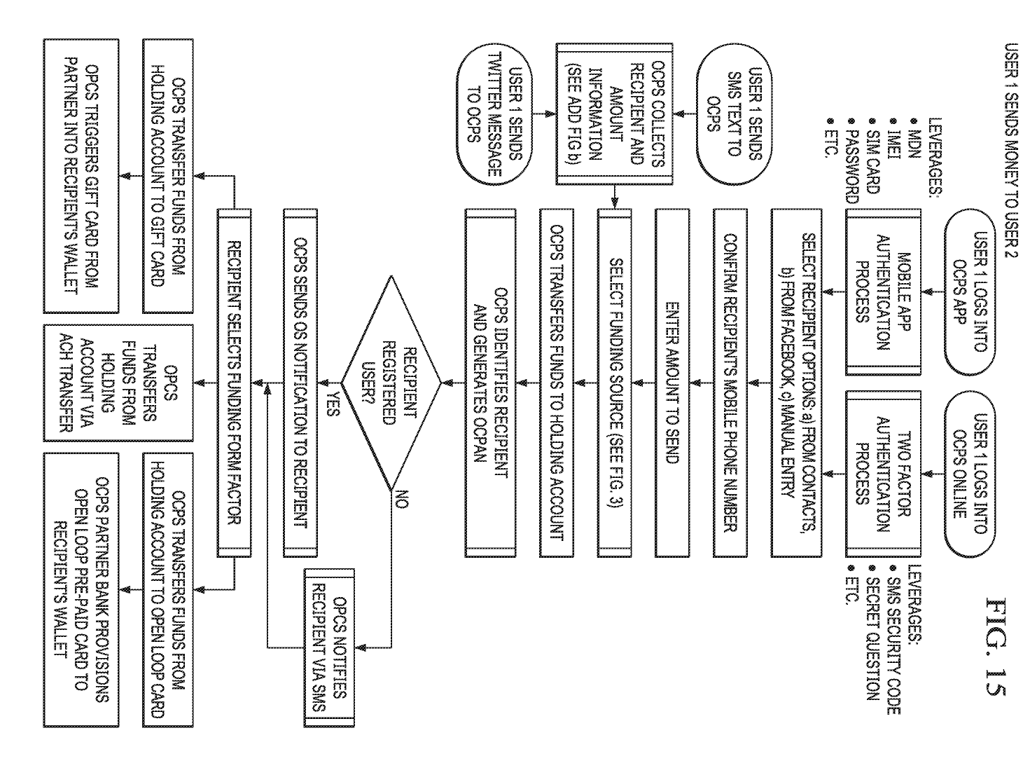

FIG. 15 illustrates an example process of how OCPS addresses many short falls of traditional virtual gift card systems, without imposing any significant compromises. OCPS may allow a user to log into their account via online or in-app methods, and apply user-authentication techniques. When a user logs in via their OCPS app, additional user validation may be available (as described elsewhere in this disclosure). The sender may then be able to see a large selection of gift cards to purchase, as provided by a 3rd party partner network. In some implementations, the OCPS may wait for the receiver's acknowledgement and form factor selection before sending the gift card (see FIG. 13). In these instances, the recipient may receive the card in a form factor that is compatible with the digital wallet of their choice. Once OCPS knows the card type, amount and form factor, it may send instructions to the 3rd party provider to provision that card into the recipient's wallet, or (depending upon the 3rd party) OCPS may directly purchase the card on behalf of the sender, and provision it directly to the recipient's digital wallet of choice.

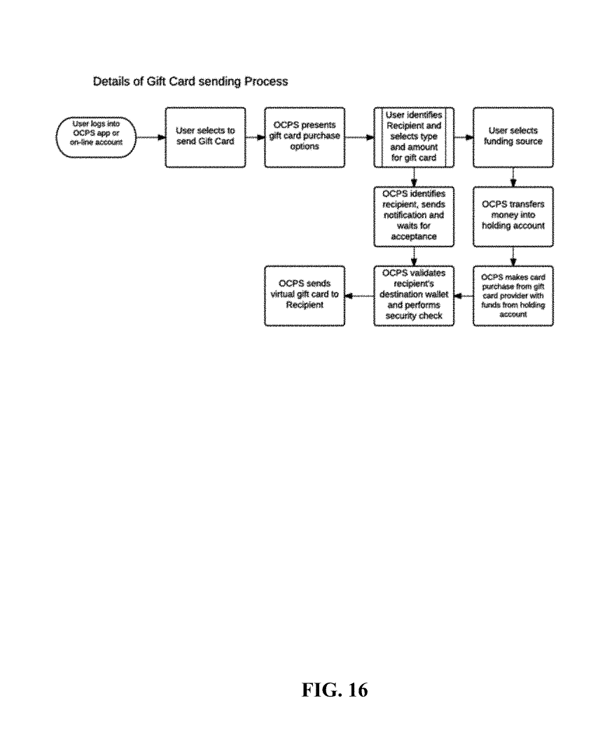

FIG. 16 illustrates example options and processes associated with conversion of payment form factors within the OCPS system. For simplicity, this diagram assumes the sender and recipient are the same person, however that is not a limitation of OCPS, as it allows the conversion the sender's payment form factor into a different form factor at the recipient, by virtue of its functionality. As illustrated, a user may start the conversion by opening their OCPS app, or logging into their online OCPS account [standard user authentication may be performed as described elsewhere in this disclosure]. Once the app/account is open, the user may then select the source of funds as an existing form factor (e.g. card with pre-paid funds). If the chosen form fact is a merchant gift card, then OCPS may call a 3rd party exchange (or merchant) to request a “cash-out” of that card. The net funds (after customary discounts and fees) are deposited into a holding fund on behalf of the user. Next, the user must select the destination form factor for these funds. This process is the same as the recipient form factor selection described elsewhere in this disclosure. Once the user's selection has been sent to the OCPS, then OCPS may perform the card provisioning or bank account transfer. The lower portion of FIG. 14 describes a variation of this process, in which the user may originate the request from 3rd party accounts which have connections with OCPS, such as a Bitcoin exchange or Coinstar redemption kiosk. In this case, the sender may identify themselves as the intended recipient and the 3rd party system may send this information along with the amount to OCPS, which then initiates a recipient validation [as described elsewhere in this disclosure]. Once completed, OCPS may confirm the transfer is ready, and request funds from the 3rd party which originated the transfer request. The rest of the process may follow standard card provisioning options and processes as described elsewhere in this disclosure.

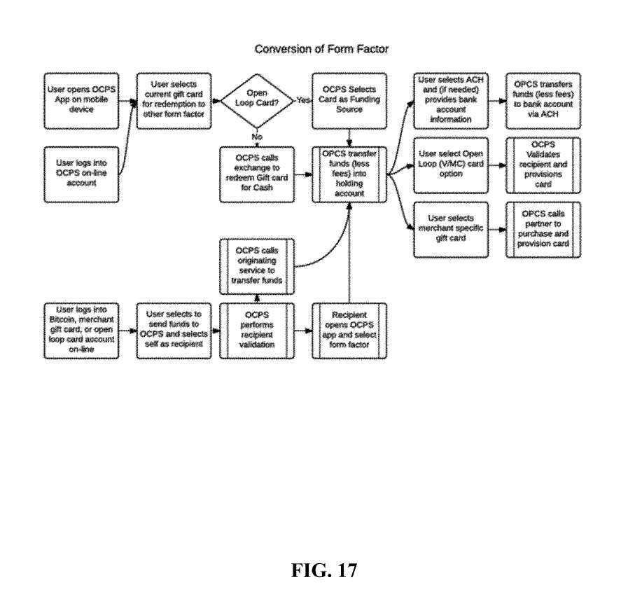

FIG. 17 illustrates an example extension of the OCPS system, which is the ability to provision pre-paid open loop and gift cards as the benefit of a manufacturer rebate program, and allow users to receive pre-paid cards provisioned to their digital wallet which are usable as NFC (or barcode) payment form factors in merchant stores. FIG. 15 illustrates an example work flow for a consumer who applies for and receives a rebate via OCPS either directly within the OCPS app, or by initiating the request on a 3rd party promotional program website. In some implementations, the rebate may be received within a short period of time such as less than 10 minutes, less than 5 minutes, less than 1 minute, less than 30 seconds, or others. In the first case, the OCPS app may include a feature enabling a user to scan the barcode of a product they recently purchased for validation against a rebate program from an OCPS partner manufacturer or promotional program manager. The OCPS system may then pass sufficient information to the promotional program partner to allow them to determine if the rebate was valid for that user. If valid, the promotional partner may allocate funds for the rebate and transfer these funds to OCPS which in turn may put into a holding account for the user. Once the user selects the desired payment form fact, the OCPS may provision the pre-paid card to the user's desired digital wallet [as described elsewhere in this disclosure]. In the second cases shown in FIG. 17, the user may perform a more traditional on-line rebate application but specifies the desire to have their rebate issued as a pre-paid card of their choice. The user may specify the destination digital wallet to the 3rd party promotional program manager website, and once that site has validated eligibility for the promotion, it provides OCPS with sufficient information and an accompanying funds transfer to allow OCPS to provision the chosen pre-paid card into the target digital wallet.

Through its capabilities, OCPS may provide one or more of the following capabilities: a) Users to be able to send money or pay someone based on a funding source available to them irrespective of whether the recipient can utilize those funds or not, b) Users to be able to convert funds sent to them in forms not immediately utilizable by them (closed loop gift card, bitcoin, cash in different currency etc.) into a form that is utilizable such as a Visa or MasterCard Virtual Card, c) Users to be able to increase the value of the gift sent to them by being able to convert money or gift card sent to them into another gift card from a merchant that leverages additional discounts, marketing promotions and sponsored promotions d) for Sending Money from one Digital Wallet into another Digital Wallet that are otherwise not belonging to the same money network such as from Apple Pay to Google Wallet, e) for recipients of sent funds to load money sent to them after conversion into a usable form into a preferred digital wallet of their choice (Apple Pay, Google Wallet or 3rd party apps such as PayPal, Amazon etc.) thereby enabling use of the funds across supported channels (online, physical stores or in-app purchases), f) Senders to combine funds from various funding sources available to them to initiate a gift of a larger value than any of the individual funding source and g) Recipients of money or gift or a particular value sent to them to be able to split them into multiple different funding choices, either closed loop gift card or open loop virtual visa or mastercard or a combination of these funding choices for redemption.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
receiving, through a communication network, digital information identifying a source network address for a sender, a funding source, the original value, and a destination network address for recipient;
transmitting, through the communication network, a notification including digital information identifying the sender, an original prepaid item, the original value, and alternative prepaid items;
receiving a response identifying one or more of the alternative prepaid items; and
transmitting, to a network element associated with the prepaid items, a request to convert the original prepaid item of the original value to one or more of the alternative prepaid items assigned with new values based on one or more predefined exchange rates.

2. The method of claim 1, wherein the value before conversion is instantly removed from the source network address for the sender, and the one or prepaid items with corresponding values assigned after conversion are added to the destination network address for the recipient

3. The method of claim 1, the funding source comprises at least one a bank card, financial account, gift card, direct deposit to a bank account, a value retaining coupon, a store credit, loyalty reward points, scanned or electronic check, voucher, stock certificate, or a cryptocurrency.

4. The method of claim 1, each of the funding source, original prepaid items and the destination alternative prepaid items are represented by at least one of a digital wallet account, a digital barcode, a network url, a token or a confirmation number that can be used to retrieve the one or more assigned value from a financial institution or a retailer.

5. The method of claim 1, the original funding source are automatically retrieved from a 3^{rd} party record keeper based upon identification information retrieved from the sender or recipient.

6. The method of claim 1, wherein the predefined exchange rate comprises at least one of an open-market published rate, an open-market unpublished exchange rate, a proprietary exchange rate, or a destination funding negotiated rate.

7. The method of claim 1, further comprises:
determining fees associated with the requested exchange;
determining a bearer of the fees;
determining a final and net value for the one or more of the alternative prepaid items based on the original value, the one or more predefined exchange rate and the fees; and
transmitting a notification to the network address for recipient identifying one or more of the alternative prepaid items and the final and net value.

8. The method of claim 1, wherein the predefined exchange rate or the final and net value can be adjusted temporarily based on at least one of a discount offered by the provider of the alternative prepaid items, promotional rate, seasonal rate, a special rate based upon market conditions, or sponsored promotions from a 3^{rd} party

9. The method of claim 1, wherein the original value comprises a first value assigned to a first funding source, the method further comprising:
receiving digital information identifying one or more supplementary funding sources, a supplementary value assigned to each of the supplementary funding sources, and the network address for recipient, wherein the request is to aggregate both the first value and the supplementary value for a value assigned to the original prepaid item and use the aggregated value for exchange to the alternative prepaid items.

10. The method of claim 1, wherein the final value to be assigned to the recipient network address comprises a first value assigned to a first alternative prepaid item, where the first value comprises a portion of the final value, the method further comprising:
receiving digital information identifying one or more supplementary alternative prepaid items, portions of the remaining value assigned to each of the supplementary prepaid items, wherein the request is to split the final value into the first value and the supplementary value to each of the alternative prepaid items.

11. The method of claim 1, wherein the digital information is received from at least one of an email, a text message, a peer to peer communication, a chat message, a multi-media message, a voice message or a social-media post.

12. The method of claim 1, wherein the notification including digital information identifies values assigned to each of the alternative prepaid items.

13. The method of claim 1, wherein the notification including digital information identifies alternative prepaid items, some of which are marked as recommended based on at least one of favorites marked by the recipient, used previously by the recipient, having a higher final value due to a favorable exchange rate or fees.

14. The method of claim 1, further comprising:
during registration, generating an 16-digit account number for the recipient based at least on the destination network address and a hardware identifier for the recipient; and
validating the recipient using the 16-digit account information.

15. A method, comprising:
upon receipt of digital information, automatically detecting a recipient digital wallet available at the recipient network address;
generating a request to provision a financial information or value associated with the prepaid item into the recipient wallet
configuring, by the recipient wallet, to automatically receive and execute the provisioning request automatically or upon confirmation from the recipient
activating, by the recipient wallet, the provisioned financial or value associated with a prepaid item instantly or in a delayed fashion
notifying, by the recipient wallet, the recipient that the provisioned prepaid item is ready for use

16. A method, comprising:
allowing the sender to indicate a target future execution date of the digital information to the recipient;
allowing the sender to indicate a validity date including begin and end for the digital information;
allowing the sender to update or cancel any un-executed digital information with or without fees; and
allowing an expired digital transfer to be logged and cancelled with or without fees.

17. A method, comprising:
allowing the recipient to accept the conversion into one or more of the selected alternative n prepaid items;
allowing the recipient to save the digital information in a temporary network account for future determination of the alternative prepaid items; and
allowing to establish a default alternative prepaid item to complete the conversion of the value sent in the digital information prior to expiration if no other alternative prepaid items are selected.

18. A server, comprising:
one or more processors configured to:
receive, through a communication network, digital information identifying a source network address for a sender, a funding source, a value, and a destination network address for recipient;
transmit, through the communication network, a notification including digital information identifying the sender, an original prepaid item, the value, and alternative prepaid items;
receive a response identifying one or more of the alternative prepaid items; and
transmit, to a network element associated with the one or more of the alternative prepaid items, a request to convert the value assigned to the original prepaid item to one or more values assigned to the one or more of the alternative one or more of the alternative prepaid items based on one or more predefined exchange rates.

19. A non-transitory computer readable medium storing instructions to cause a processor to perform operations comprising:
receiving, through a communication network, digital information identifying a source network address for a sender, a funding source, a value, and a destination network address for recipient;
transmitting, through the communication network, a notification including digital information identifying the sender, an original prepaid item, the value, and alternative prepaid items;
receiving a response identifying one or more of the alternative prepaid items; and
transmitting, to a network element associated with the one or more of the alternative prepaid items, a request to convert the value assigned to the original prepaid item to one or more values assigned to the one or more of the alternative one or more of the alternative prepaid items based on one or more predefined exchange rates.
